(19) United States
(12) Patent Application Publication
(10) Pub. No.: US 2008/0303271 A1
(43) Pub. Date: Dec. 11, 2008

(54) Flexible fluid filler tool

(76) Inventors: Michael Shevela, Harrison Township, MI (US); Brian Echtinaw, Sterling Heights, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/808,052

(22) Filed: Jun. 6, 2007

(51) Int. Cl. F16L 11/14; F16L 37/00

(52) U.S. Cl. 285/148.3; 285/148.2

(57) ABSTRACT

A fluid filler tool and method of use are provided that allow a user to easily fill a fluid containing device such as a transmission with fluids. The fluid filler tool includes a quick-connect fitting and a cone tip end. The quick-connect fitting mates with a fluid filling device and the cone tip mates with the transmission. The fluid filler tool is made from steel and is flexible so that it retains the configuration that is desired by the user.

### FIELD OF THE INVENTION

The present invention relates generally to a fluid filler tool. More particularly, the present invention relates to flexible fluid filler tool for use to fill fluids in a transmission of a vehicle.

### BACKGROUND OF THE INVENTION

Transmissions are used in an engine in order to provide speed-power conversion. An engine can provide a certain maximum rotation per minute or speed within a small range. With help of a transmission and its gear box, the engine's speed can be translated into a larger range of output speed. The transmission can be a manual transmission, where a person has to manually “shift” gears of the transmission or it can automatic, where a person does not have to “shift” the gears because the transmission includes components that “know” when to “shift” the gears.

Manual and automatic transmissions need hydraulic fluids in order to function properly. For example, automatic transmission can include a gear pump, which may be located in the cover of the transmission. The pump draws fluid from a transmission pan located at the bottom of the transmission and feeds it to the hydraulic system. The pump also feeds the transmission cooler and the torque converter with the necessary fluids.

Transmission fluid needs to be replaced when it gets dirty or when it is low. A dipstick in the transmission is typically used to determine the level of the fluid and also can be used as a conduit to add transmission fluid. However, the dipstick opening is typically small and requires the use of a funnel in order to add the fluid without spilling. The fluid is typically bright red and has a petroleum smell. If the fluid is different in color and has a different smell, such as a “burnt” smell, then it needs to be replaced.

Newer vehicles may not be equipped with a dip stick so that maintaining the proper fluid level requires the removal of the transmission pan. Removing the transmission pan adds time and cost to the repair. Additionally, the new transmissions have fluid filler ports, but this requires a special tool in order to utilize such ports. Accordingly, it is desirable to provide a method and apparatus that can readily refill the transmission fluid via the fluid filler ports or without the use of a funnel.

### SUMMARY OF THE INVENTION

The foregoing needs are met, to a great extent, by the present invention, wherein in one aspect an apparatus is provided that in some embodiments a flexible hose is provided that can mate with various transmissions and fill them with transmission fluid.

In accordance with one embodiment of the present invention, a fluid filler tool for use in a vehicle is provided, which can include a flexible hose having a first end and a second end, the hose can be designed to transfer fluids, a quick-connect fitting can be coupled to the first end of flexible hose, the fitting can be designed to mate with a complementary fitting on a fluid filling device, and a cone tip coupled to a second end of the flexible hose, the cone tip can be designed to mate with a device in a vehicle that uses fluids.

In accordance with another embodiment of the present invention, a method of filing a fluid containing device in a vehicle is provided and can include connecting an adapter to a first end of a flexible steel hose, bending the flexible steel hose to a desired shape, connecting the first end of the flexible steel hose to a fluid filling device, and connecting a second end of the flexible steel hose to a device in the vehicle machine that uses fluid.

In accordance with yet another embodiment of the present invention, a fluid filler tool is provided, which can include a means for transferring fluids having a first end and a second end, wherein the means for transferring fluids can be manually configured to a desired configuration, a means for quick-connecting coupled to the first end of the means for transferring fluids, the means for quick-connecting is designed to mate with a complementary fitting on a fluid filling device, and a means for mating coupled to a second end of the flexible hose, the means for mating is designed to mate with a device that uses fluids.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings.

The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a filler tool according to an embodiment of the invention.

FIGS. 2A-2C illustrate various configurations of the fluid filler tool that a user can manipulate.

FIG. 3 illustrates an exemplary use of the fluid filler tool.

### DETAILED DESCRIPTION

The invention will now be described with reference to the drawing figures, in which like reference numerals refer to like parts throughout. An embodiment in accordance with the present invention provides a fluid filler tool for use to fill fluids in a fluid containing device, such as a transmission of a vehicle.

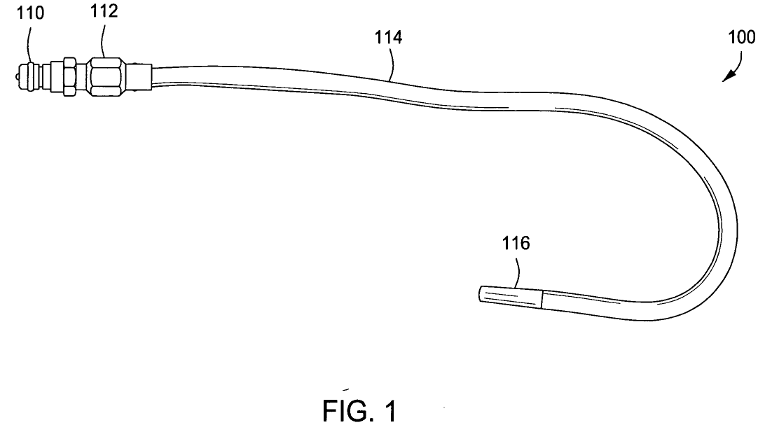

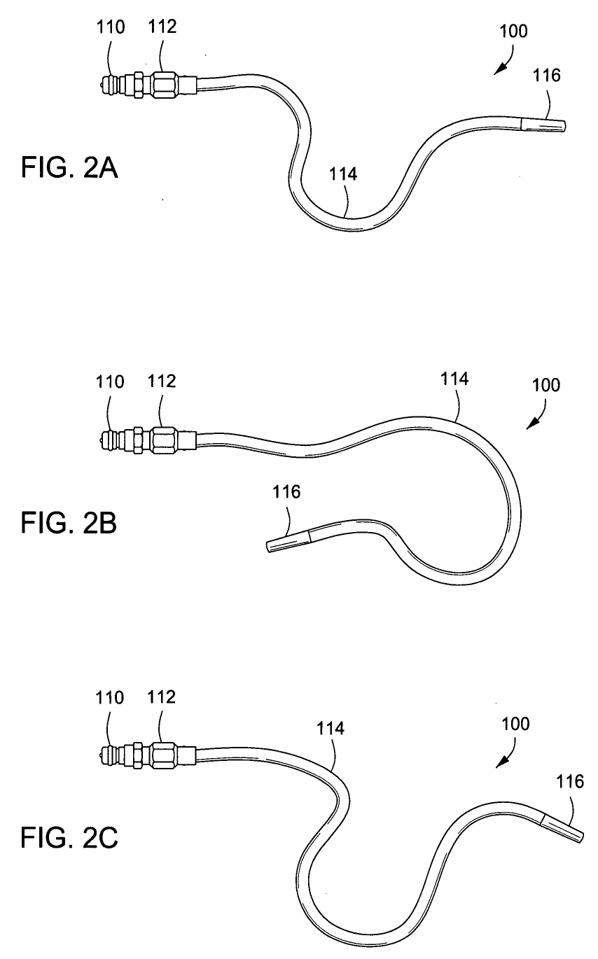

FIG. 1 illustrates a fluid filler tool 100 according to an embodiment of the invention. The fluid flexible tool 100 includes flexible steel hose 114 having a quick-connect fitting 112 at a first end and a cone tip 116 at a second end. The flexible steel hose 114 can include steel, where the hose is constructed and designed to be flexible so that it can be shaped, bent, twisted or otherwise manipulated as needed (See FIGS. 2A-C). The steel may intertwine or weaved so that the hose can be flexible and fluid tight. The flexible steel hose can be bent any numbering of degrees including 180 degrees (cone tip in relation to the quick-connect fitting). The flexible steel can be constructed and arranged to have fluids flow there through from a fluid source to the fluid containing device without leaking. However, the flexible steel hose can include a nylon sheath that functions as an additional measure to prevent any fluid that may have escape from the steel hose. The nylon sheath also prevents the flexible steel hose from scratching parts of the vehicle while the transmission is being filled. The nylon sheath is constructed and designed to be flexible as the steel hose.

At the first end is a quick-connect fitting 112 that is designed to be matted with an adapter 110. The quick-connect fitting 112 can mate with any adapter of a fluid source as desired by the user. The quick-connect fitting includes a first and second end. In one embodiment, the first end of the quick-connect fitting can mate with the adapter 110 and has a larger diameter than the second end which mates with the flexible steel hose. In other embodiments, the first and second ends of the quick-connect fitting have the same diameters or the second end's diameter is larger than the first end's diameter. The first and second ends of the quick-disconnect should form a fluid tight seal as to prevent any fluid leaking at the ends. The quick-connect fitting 112 can be made from any suitable material such as brass, steel, aluminum, alloys, and the like.

The adapter 110 shown on FIG. 1 is used to mate to a fluid filling device, such as a TransFlow™ from Service Solutions, a unit of SPX Corporation (Charlotte, N.C.). The TransFlow™ is used to recycle transmission fluid from the transmission in a vehicle. It includes fluids for use by the transmission. The adapter 110 is designed to mate with the TransFlow™ at one end and the quick-connect fitting 112 at the other end. Once attached, the fluid from the Transflow™ can flow through the fluid filler tool 100 to the transmission.

At the second end of the flexible hose is the cone tip 116. The cone tip 116 is constructed and arranged to mate with a port of the transmission in order to fill the transmission with transmission fluid. The cone tip can be made from any materials including brass, steel, aluminum, tin, alloys, synthetics, polymers and the like. The materials chosen should be able to withstand the continuous inserting and removing from the port in the transmission and other fluid containing device without being easily damaged. The cone tip 116 includes a first and a second end. The first end couples with the flexible hose 114 and has a larger diameter then the second end. The second end mates with the fill port of the transmission. The cone tip 116 is designed so that it can be self-centering on the port. The cone tip second end's diameter is smaller than the first end so that the cone tip can easily fit into various sized ports. Although a transmission is used herein as an example, the cone tip 116 can mate with other devices such as a vehicle, washer fluids, brake fluids and the like.

FIGS. 2A-C illustrate various configurations of the fluid filler tool 100 that a user can manipulate. By being able to manipulate the fluid filler tool the user can shape the tool into any configurations needed to fill the fluid containing device. Given the various transmission configurations that are faced by the user, the tool can be easily adapted to various transmission configurations without the user having to have a filler tool for every transmission.

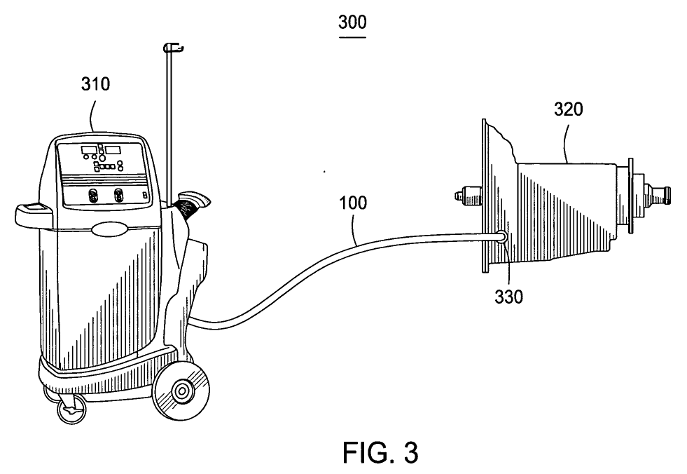

FIG. 3 illustrates an examplary use of the fluid filler tool 100. The TransFlow™ machine having transmission fluid is connected to the fluid filler tool 100. As stated above, the fluid filler tool 100 can have the adapter 110 at an end that can mate with the TransFlow™. At the other end, the fluid filler tool can mate with a filling hole 330 in a transmission 320 via the cone tip. The filling hole will generally be available in a transmission that does not have a dip stick. Alternatively, the cone tip can mate with the dip stick of the transmission.

The fluid filler tool is designed to transfer fluids from a fluid filling device to a fluid containing device such as a transmission. As noted above, some new transmissions do not include a dipstick for use in filling the transmission with fluid and requires the technician to remove the fluid pan. This can take considerable more time when servicing the transmission. With the fluid filter tool, the technician can provide fluids to the transmission through ports holes in the transmission without the need to removing the fluid pan. Even if the port is not easily accessible, the fluid filler tool can be manipulated and bent in various shapes and degrees in order to reach such ports. The fluid flexible can be made from any material that is bendable, twistable or otherwise shapeable. The material can be a polymer, tin, alloy, brass, aluminum, or any other suitable material.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A fluid filler tool for use in a vehicle, comprising:
a flexible hose having a first end and a second end, the hose is designed to transfer fluids;
a quick-connect fitting coupled to the first end of flexible hose, the fitting designed to mate with a complementary fitting on a fluid filling device; and
a cone tip coupled to a second end of the flexible hose, the cone tip is designed to mate with a device in the vehicle that uses fluids.

2. The fluid filler tool of claim 1, wherein the flexible hose further comprises of steel.

3. The flexible tool of claim 2, wherein the flexible hose can be manipulated to a desired configuration and holds the desired configuration.

4. The flexible tool of claim 1, wherein the quick-connect fitting includes an adaptor that mates with the complementary fitting.

5. The flexible tool of claim 1, wherein the cone tip has first end and a second end, the first end has a larger diameter than a diameter of the second end.

6. The flexible hose of claim 2, wherein the steel is covered with a nylon sheath.

7. The flexible hose of claim 1, wherein the cone tip can be bent up to 180 in relation to the quick-connect fitting.

8. The flexible hose of claim 1, wherein the device is a transmission.

9. A method of filing a fluid containing device in a vehicle, comprising:
connecting an adapter to a first end of a flexible steel hose;
bending the flexible steel hose to a desired shape;
connecting the first end of the flexible steel hose to a fluid filling device; and
connecting a second end of the flexible steel hose to a device in the vehicle that uses fluid.

10. The method of claim 9 further comprising flowing fluid through the flexible steel hose from the fluid filling device to the device that uses fluids.

11. The method of claim 9, wherein the device is a transmission.

12. The method of claim 9, wherein connecting the second end of the flexible steel hose to the device that uses fluid is connecting the second end to a fill port in the device.

13. A fluid filler tool for use in a vehicle, comprising:
a means for transferring fluids having a first end and a second end, wherein the means for transferring fluids can be manually configured to a desired configuration;
a means for quick-connecting coupled to the first end of the means for transferring fluids, the means for quick-connecting is designed to mate with a complementary fitting on a fluid filling device; and
a means for mating coupled to a second end of the flexible hose, the means for mating is designed to mate with a device in the vehicle that uses fluids.

14. The fluid filler tool of claim 13, wherein the means for quick-connecting is a quick-connect fitting and the means for mating is a cone tip.

15. The fluid filler tool of claim 13, wherein the means for transferring fluids further comprises of steel.

16. The fluid filler tool of claim 13, wherein the means for transferring fluid can be manipulated to a desired configuration and holds the desired configuration.

17. The fluid filler tool of claim 13, wherein the means for quick-connecting included an adaptor that mates with the complementary fitting.

18. The flexible tool of claim 13, wherein the means for mating has first end and a second end, the first end has a larger diameter than a diameter of the second end.

19. The flexible hose of claim 15, wherein the steel is covered with a nylon sheath.

20. The flexible hose of claim 1, wherein the means for mating can be bent up to 180 in relation to the means for quick-connecting.

21. The flexible hose of claim 13, wherein the device is a transmission.
